(19) United States
(12) Patent Application Publication
(10) Pub. No.: US 2026/0143294 A1
(43) Pub. Date: May 21, 2026

(54) SMART SOUND LEVEL METER FOR PROVIDING REAL-TIME SOUND LEVEL TRACING

(71) Applicant: Soundtrace Inc., Loveland, OH (US)

(72) Inventor: Jeffrey Wilson, Loveland, OH (US)

(21) Appl. No.: 19/057,847

(22) Filed: Feb. 19, 2025

Related U.S. Application Data
(63) Continuation of application No. 17/686,691, filed on Mar. 4, 2022, now abandoned.
(60) Provisional application No. 63/157,425, filed on Mar. 5, 2021.

(51) Int. Cl. H04R 29/00; G01H 3/12; G01H 7/00; H04R 3/00

(52) U.S. Cl. CPC H04R 29/008; G01H 3/12; G01H 7/00; H04R 3/005; H04R 2430/01

(57) ABSTRACT

An IoT Smart Sound Level Meter that is connected through the internet via ethernet cable, wifi or cellular network. The IoT Smart Sound Level Meter measures and monitors sound pressure levels. Sound pressure levels are measured in decibels. The sound pressure level data that is sent via the internet through ethernet, wifi or cellular network to cloud servers where the data is stored and saved. The cloud servers are connected to Application Programming Interfaces (API) connected to web-based software that converts the sound pressure level data into decibel measurements. These measurements are displayed to the end-user through the web-based software and/or application providing real-time decibel level measurements and historic sound pressure level recordings. The web-based software and/or application provides access to view decibel measurement data remotely from a computer, laptop, tablet, smart watch, or mobile device.

### PRIORITY

This application is a continuation of U.S. application Ser. No. 17/686,691, entitled “Smart Sound Level Meter for Providing Real-Time Sound Level Tracing,” filed Mar. 4, 2022, which claims the benefit of U.S. Provisional Patent Application No. 63/157,425, entitled “Smart Sound Level Meter for Providing Real-Time Sound Level Tracing,” filed Mar. 5, 2021, both of which are incorporated herein by reference in their entirety.

### FIELD OF THE INVENTION

The invention relates generally to an Internet of Things (IoT) device that measures, monitors, and records sound pressure levels and that is connected to cloud servers, application programming interface and web-based applications that save, store, predict and convert the sound pressure level data into decibel measurements, providing end-user access and visibility to real-time, historic and predictive decibel measurements.

### BACKGROUND

The Centers for Disease Control and Prevention (CDC) has estimated that twenty-two million United States workers are exposed to hazardous noise levels annually, causing hearing loss to be one of the most common work-related illnesses. Noise induced hearing loss (NIHL) is a permanent injury as there is no present cure. Hearing loss can also lead to other health effects such as tinnitus, depression, anxiety, high blood pressure, dementia and other health, social and physiological impacts. Noise induced hearing loss for workers can result in lost wages, lost ability to work and other lifetime challenges, causing an estimate of over $242 million in annual workers' compensation settlements and expensive fines by the Occupational Safety & Health Administration (OSHA), which mandates occupational sound pressure level or noise level monitoring. In the United States alone, hearing loss has an annual economic impact of $133 billion. This is due to loss of productivity, underemployment, unemployment, early retirement, healthcare and other related costs. However, current noise monitoring methods are out of date, unreliable and inaccurate.

In this regard, the current state of measuring occupational sound pressure levels is performed through sound level meters and/or noise dosimeters that are not connected to a cloud server and web-based software. In order to implement conventional sound level meters, a dedicated employee must typically record and log noise levels throughout the facility on a periodic basis. This process is time-consuming, inconsistent, manual, and error prone. Moreover, recording sound levels on a periodic basis does not reflect a full picture of the sound levels experienced by the employees as there are gaps in time when sound levels are not recorded. In order to implement conventional noise dosimeters, each employee must typically wear a noise dosimeter (e.g., on the employee's uniform) throughout the entire work day. This process is expensive (e.g., costing between approximately $750 and approximately $1,500 per dosimeter/employee), subject to poor adoption by employees, and often only actually used on a periodic basis and/or by certain employees. Unless every employee wears a dosimeter every day, the measured sound levels do not reflect a full picture of the sound levels experienced by the employees as there are again gaps in the sound measurements.

With current sound level meters and dosimeters sound levels are restricted to time and place measurements. Periodic time, place or personnel measurements demand employers to estimate total noise exposure levels based on limited data or recordings. It would be highly advantageous to provide an alternative sound pressure level measuring method and system that continuously measures, records, monitors and saves sound levels through a cloud-based software, providing the end-user visibility to decibel levels remotely in real-time, anytime. In addition, providing predictive decibel measurements can supply critical information of potential harmful sound levels, allowing employers the opportunity to fix, protect or avoid potential sound hazards.

Hearing protection devices (HPD) such as safety earplugs and earmuffs are graded on a scale called Noise Reduction Rating (NRR). The NRR scale typically ranges from NRR20 to NRR33. The NRR ratings are based on laboratory conditions, therefore calculations to derate the noise reduction rating should be made to reflect real world workplace conditions. However, a common misunderstanding is assuming the hearing protection device NRR rating is reducing real-world decibel exposure by that NRR number. Conversely, the Noise Reduction Rating is based on controlled laboratory settings and does not account for outside interferences. For example, if a worker is exposed to noise levels of 100 decibels in a work environment and is wearing hearing protection (e.g., earplugs) with a rating of NRR22, their personal noise exposure is not 78 decibels but instead 92.5 decibels or higher. This adjustment can be estimated with a derating equation such as (NRR-7)/2=actual decibel level reduction. In the present example, 100 db−[(22−7)/2]=92.5 decibels. Other examples of calculating noise attenuation of hearing protection and derating noise reduction values are listed in the table below, where dBA is the unit representing the sound level measured with the A-weighting network, and dBC is the unit representing the sound level measured with the C-weighting network.

| | | | Dual Protection |
|---|---|---|---|
| HPD | Earplugs | Earmuffs | (Earplugs + Earmuffs) |
| NRR Achieved | 50% | 70% | 65% |
| dBA Calculation | L_{eq} − [NRR (0.50 − 3] = XX dBA | L_{eq} − [NRR (0.7 − 3] = XX dBA | L_{eq} − [(NRR + 5) (0.65) − 3] = XX dBA |
| dBC Calculation | L_{ceq} − NRR (0.5) = XX dBA | L_{ceq} − NRR (0.7) = XX dBA | L_{ceq} − (NRR + 5) (0.65) = XX dBA |

To accurately use the derating calculation formulas identified or ones similar it is also important to note the noise dose. The personal noise dose is the amount of actual noise exposure relative to the amount of allowable noise exposure.

Additionally, it is important to understand how sound wave dispersion works. In controlled free field conditions such as an anechoic chamber or testing laboratory, noise is an isotropic sound wave that will radiate outwards equally in all directions. Noise levels decrease as the distance increases between the source and the receiver, due to geometric dispersion. In a controlled free field condition, sound will decrease by 6 decibels per doubling distance. Since most work environments are not controlled, multiple factors affect dispersion of sound waves and ultimately the person's actual noise exposure or sound pressure level. This includes but not limited to geometric effects like distance, size, space, location; and atmospheric effects such as air quality, air absorption, wind, temperature, humidity and other air and temperature gradient factors. Additionally, sound waves can be disturbed by other elements such as magnetic interference, ground, surface, water, barriers and more.

There are secondary consequences from the listed environmental factors as well. For example, in cold temperatures a furnace may operate, therefore creating additional noise pollution to that area. If the temperature continues to decrease, the furnace may work harder therefore generating greater noise producing levels. This example may be true for other equipment and machinery in a work environment.

While certain devices and methods for monitoring sound levels are known, it is believed that no one prior to the inventors has made or used the invention described in the appended claims.

### BRIEF DESCRIPTION OF THE DRAWINGS

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 depicts a floorplan of a facility equipped with an exemplary sound level monitoring system;

FIG. 2 depicts a front elevational view of an exemplary sound level meter of the sound level monitoring system of FIG. 1;

FIG. 3 depicts an exemplary end-user workflow of the sound level monitoring system of FIG. 1;

FIG. 4 depicts an exemplary infrastructure workflow of the sound level monitoring system of FIG. 1;

FIG. 5 depicts an exemplary user interface of the sound level monitoring system of FIG. 1;

FIG. 6 depicts an exemplary historic sound level report generated by the sound level monitoring system of FIG. 1 in response to user input received via the user interface of FIG. 5;

FIG. 7A depicts an exemplary implementation of the user interface of FIG. 5 on a display of a laptop computer;

FIG. 7B depicts another exemplary implementation of the user interface of FIG. 5 on a display of a tablet;

FIG. 7C depicts another exemplary implementation of the user interface of FIG. 5 on a display of a smartphone;

FIG. 8 depicts an exemplary method for monitoring sound levels that may be performed by the sound level monitoring system of FIG. 1;

FIG. 9 depicts an exemplary implementation of the user interface of FIG. 5 on the display of FIG. 7A, with the user interface toggled to visually communicate additional data to the user;

FIG. 10 depicts a schematic view of an exemplary work environment, showing sound traveling through multiple mediums that intensify or lessen sound pressure levels; and

FIG. 11 depicts another exemplary method for monitoring sound levels that may be performed by the sound level monitoring system of FIG. 1.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

In some instances, it may be desirable to improve current sound monitoring inefficiencies by providing intelligent sound pressure level data at all times including predictive sound level data through artificial intelligence calculated from historic sound level data and patterns. The present disclosure is directed generally to an Internet of Things (IoT) instrument, process and system, of measuring, monitoring, recording and saving real-time occupational decibel levels that is embodied in a web-based interface or app that displays decibel level measurements. Through Application Programing Interface (API) sound level data is accessible on a computer, tablet or personal computing device. The IoT instrument is designed for but not limited to occupational noise monitoring. The IoT instrument is connected to the internet via ethernet, WiFi or cellular network sending cloud servers the recorded sound level data, the cloud servers connect through API to a web-based software for end users/subscribers to view current, historic and/or predictive future sound pressure levels.

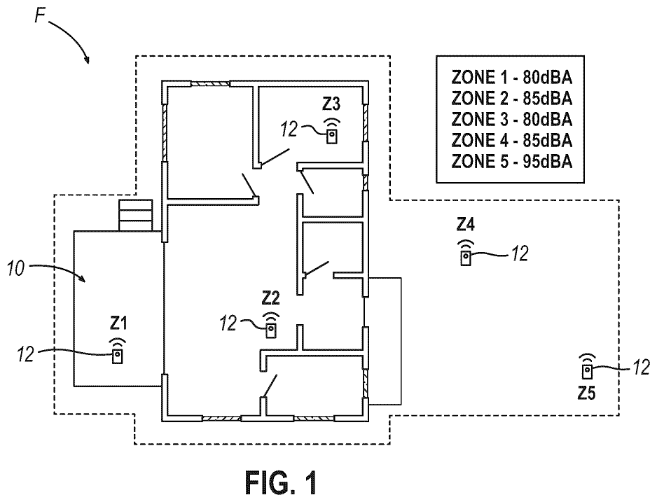

FIG. 1 depicts a facility (F) equipped with an exemplary sound level monitoring system (10) including a plurality of sound level meters (or “sound level pressure meters”) (12). As shown, facility (F) includes a plurality of noise exposure zones (Z1, Z2, Z3, Z4, Z5), which may each include one or more rooms, room portions, objects (e.g., machines or other sources of sounds) within rooms, and/or other areas of facility (F). Zones (Z1, Z2, Z3, Z4, Z5) may be identified based on a predetermined amount of noise exposure that employees or other personnel are subject to experience when positioned (e.g., working, standing, sitting, etc.) therein. For example, zones (Z1, Z2, Z3, Z4, Z5) may be identified based on a determination that employees positioned therein are subject to experience sound levels greater than or equal to a threshold sound level, such as 80 dBA. In the example shown, first zone (Z1) may have a sound level of approximately 80 dBA, second zone (Z2) may have a sound level of approximately 85 dBA, third zone (Z3) may have a sound level of approximately 80 dBA, fourth zone (Z4) may have a sound level of approximately 85 dBA, and fifth zone (Z5) may have a sound level of approximately 95 dBA. These exemplary sound levels are provided for illustrative purposes only and are not intended to be limiting.

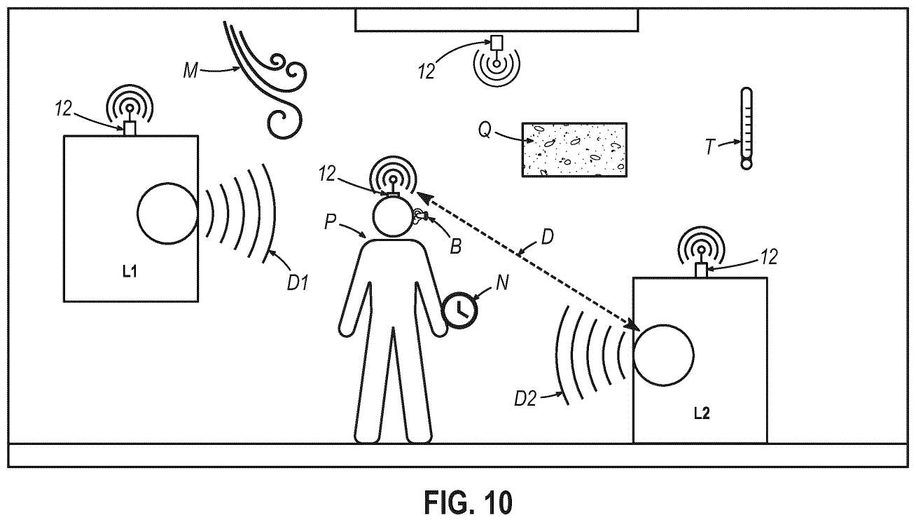

In the example shown, a corresponding sound level meter (12) is positioned within each of zones (Z1, Z2, Z3, Z4, Z5). For example, each sound level meter (12) may be fixedly positioned with the respective zone (Z1, Z2, Z3, Z4, Z5), such as at a suitable location for obtaining accurate and reliable measurements of the sound levels within the respective zone (Z1, Z2, Z3, Z4, Z5). In this regard, each sound level meter (12) may be positioned to capture substantially the same sounds that employees within the respective zone (Z1, Z2, Z3, Z4, Z5) are subject to exposure to (e.g., near ear-level). In addition or alternatively, each sound level meter (12) may be positioned at or near a source of sound (e.g., a loud machine) within the respective zone (Z1, Z2, Z3, Z4, Z5). In some versions, multiple sound level meters (12) may be positioned within one or more zones (Z1, Z2, Z3, Z4, Z5). In other versions, one or more sound level meters (12) may be positioned elsewhere in or around facility (F) outside of zones (Z1, Z2, Z3, Z4, Z5), such as in areas of facility (F) with sound levels less than the threshold sound level. In some scenarios an employee may be exposed to multiple noise exposure zones (Z1, Z2, Z3, Z4, Z5) throughout the workday. In this case, a sound level meter (12) may be carried or fixed to the employee's attire, body, or personal equipment, as shown in FIG. 10. In addition, or alternatively, the various sound level meters (12) shown in FIG. 1 may integrate with additional applications and devices such as personal computing devices to determine the time, distance and location of the employee's noise exposure.

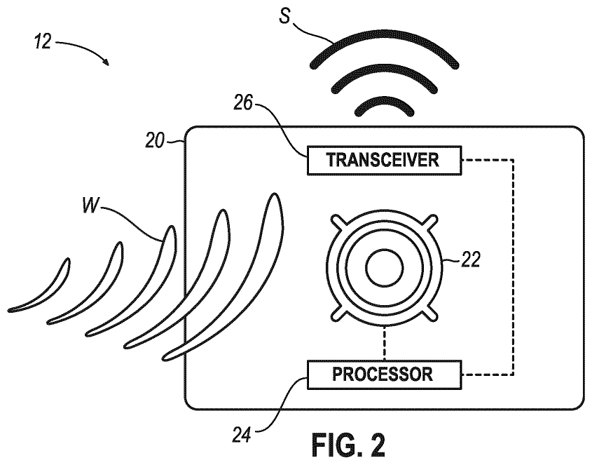

Referring now to FIG. 2, each sound level meter (12) of the present example includes a housing (20) and at least one acoustic sensor in the form of one or more microphone(s) (22) secured to housing (20) and operable to receive and measure the sound pressure levels (SPLs) of soundwaves (W), such as any soundwaves (W) traveling through the air within the respective zone (Z1, Z2, Z3, Z4, Z5). In some versions, microphone(s) (22) may be coupled externally to housing (20) via wiring. For example, a first end of a wire (not shown) may be secured to housing (20) and the wire may extend from the housing by a distance (e.g., about 20 feet) with a microphone secured at a second end of the wire opposite the first end. In addition, or alternatively, microphone(s) (22) may be externally paired to housing (20) through bluetooth, WIFI, radio frequency or other connectivity methods. Microphone(s) (22) may use similar connectivity methods with other devices such as personal computing devices.

In some versions, microphone (22) may include a diaphragm (not shown) configured to move in response to changes in air pressure caused by soundwaves (W), and such movement may be converted into an electrical signal indicative of the SPL of the soundwaves (W), which may be referred to as the captured raw SPL data. Microphone(s) (22) may have an accuracy reading of ±2 dBA or better. In some versions, a desired accuracy level of microphone(s) (22) may be achieved and/or maintained through remote calibration or other calibration methods. It will be appreciated that any other suitable types of microphone(s) (22) or acoustic sensor(s) with any suitable accuracy reading may be used to receive and measure the SPL of soundwaves (W). In any event, sound level meter (12) of the present example further includes a processor (24), such as a microprocessor, secured within housing (20) and operatively coupled to microphone(s) (22) for receiving the raw SPL data therefrom. As shown, sound level meter (12) also includes a transceiver (26) operatively coupled to processor (24) to communicate various signals(S) to and from processor (24) as described below. In this regard, transceiver (26) may be configured to communicate such signals(S) via either a wired or wireless network using any suitable communications protocol. For example, transceiver (26) may be configured to communicate such signals(S) via any one or more of a cellular (e.g., LTE) network, a WiFi network, and/or an ethernet network. While transceiver (26) is shown in the present example, sound level meter may alternatively include a transmitter and/or a separate receiver each operatively coupled to processor (24). In some versions, processor (24) may access, via transceiver (26), a web-based software or application configured to convert the raw SPL data into sound level measurements, such as decibel measurements (e.g., by applying a logarithmic conversion to the SPLs), and may communicate such sound level measurements to one or more recipients via transceiver (26). While not shown, sound level meter (12) may also include a power source, such as a rechargeable battery, for supplying power to microphone (22), processor (24), and/or transceiver (26).

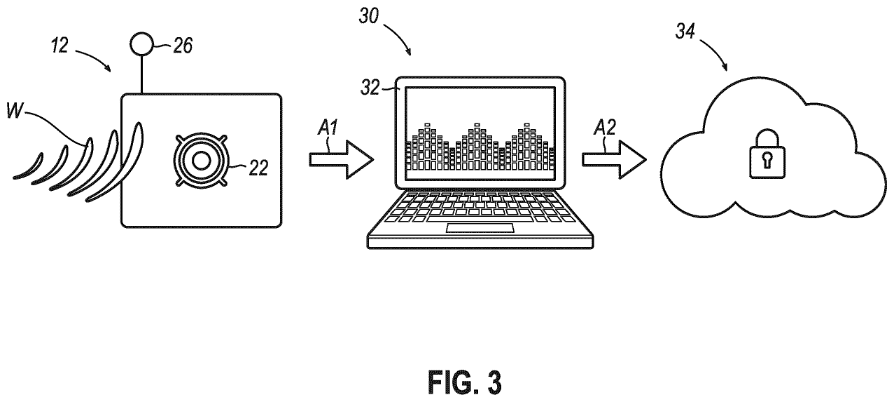

As shown in FIG. 3, one or more soundwaves (W) may be received by microphone (22) of sound level meter (12), which may generate the raw SPL data and communicate the raw SPL data to the respective processor (24) (not shown in FIG. 3). Processor (24) may then convert the raw SPL data into one or more sound level measurements, and transceiver (26) of sound level meter (12) may communicate the sound level measurements to a user interface device, such as a laptop computer (30), as indicated by first arrow (A1) in FIG. 3. It will be appreciated that laptop computer (30) (or other computing device) may be positioned in a remote location relative to sound level meter (12), such as outside of the corresponding zone (Z1, Z2, Z3, Z4, Z5). In any event, laptop computer (30) may visually communicate the sound level measurements to an end user, such as via a display (32) of laptop computer (30) as described in greater detail below. In the example shown, the sound level measurements are also communicated to a cloud-based storage (34) for subsequent retrieval, as indicated by second arrow (A2) in FIG. 3. While FIG. 3 shows the sound level measurements communicated to cloud-based storage (34) by a transmitter of laptop computer (30), communication of the sound level measurements to cloud-based storage (34) may be performed directly by transceiver (26) of sound level meter (12). In some versions, the sound level measurements may be communicated directly by transceiver (26) to cloud-based storage (34), which may then communicate the sound level measurements to laptop computer (30).

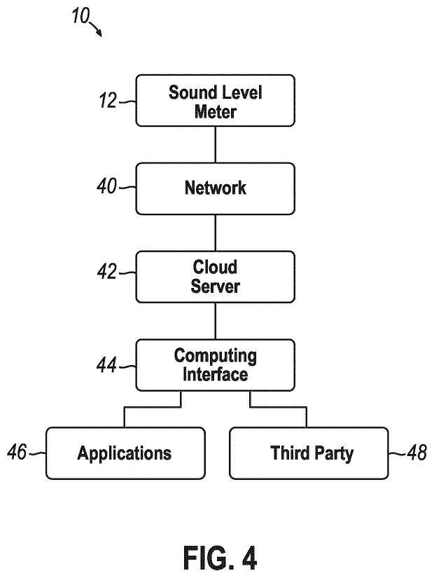

As shown in FIG. 4, system (10) may include at least one sound level meter (12) (e.g., one or more sound level meters (12) per zone (Z1, Z2, Z3, Z4, Z5)), a communication network (40), a cloud server (42), a computing interface (44), applications (46), and any associated third party integrations (48). More particularly, the at least one sound level meter (12) may include any suitable number of sound level meters (12) each having a respective microphone (22), processor (24), and transceiver (26) as described above. The at least one sound level meter (12) may be in operative communication, such as via the respective transceiver (26), with network (40), which may include any one or more of a cellular (e.g., LTE) network, a WiFi network, and/or an ethernet network, for example. The at least one sound level meter (12) may thus be connected to the internet through network (40). In any event, network (40) may, in turn, be in operative communication with cloud server (42), which may be configured to provide any one or more of data management, data storage, and/or recordkeeping of sound pressure level data (e.g., via cloud-based storage (34)). In this regard, sound level measurements obtained via the at least one sound level meter (12) may be sent through network (40) to cloud server (42). Cloud server (42) may, in turn, be in operative communication with computing interface (44), which may include open API and connectors, for example, for providing a general layer on top of the cloud data. Any one or more applications (46) and/or third party integrations (48) may flow through computing interface (44). In this regard, applications (46) may include any one or more of user management applications, computer/tablet/mobile device/smart watch applications, algorithms/artificial intelligence applications, remote calibration applications, data visibility applications, analytics applications, date and time applications, reports applications, GPS applications, and/or sound pressure level conversion to decibels applications. In some versions, computing interface (44) is configured to provide the sound level measurement(s) in response to a digital request from a software application, such as any of applications (46).

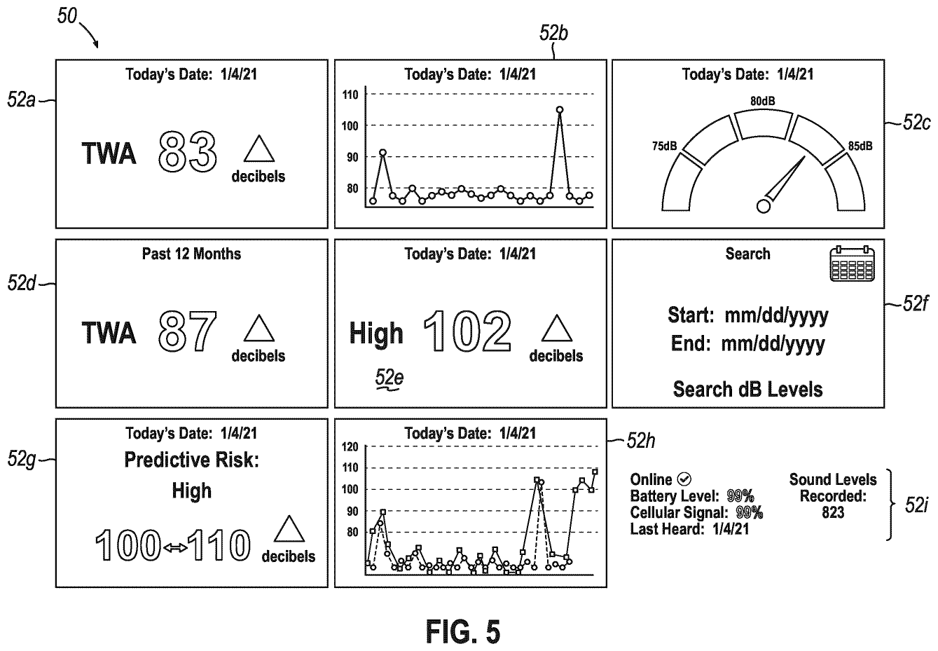

Referring now to FIG. 5, an exemplary user interface (50) of system (10) includes a plurality of indicia (52a, 52b, 52c, 52d, 52e, 52f, 52g, 52h, 52i) for visually communicating various types of data or other information regarding one or more sound level meters (12) (and/or their corresponding zones (Z1, Z2, Z3, Z4, Z5)) to the user.

In the example shown, first indicia (52a) visually communicates a real-time decibel measurement reading from sound level meter (12) in a numerical form. First indicia (52a) of the present example includes a time-weighted average (TWA) presented as a numeral measured in decibels, which may be acquired via a formula that is divided over a predetermined time period to calculate the average sound level within the predetermined time period. The numerals presented may be color-coded to assist the user in determining the risk associated with the current level of sound, such as in a manner similar to that described below with respect to third indicia (52c). For example, first indicia (52a) in FIG. 5 shows the TWA presented as 83 dBA, which may be color-coded as orange. In some versions, first indicia (52a) may also include the current date and/or time.

In the example shown, second indicia (52b) visually communicates a real-time decibel measurement reading from sound level meter (12) in a graphical form. Second indicia (52b) of the present example includes a Y-axis representing decibel levels and an X-axis representing a predetermined time period. For example, second indicia (52b) in FIG. 5 shows decibel levels plotted versus time over the course of a single day. In some versions, second indicia (52b) may also include the current date and/or time.

In the example shown, third indicia (52c) visually communicates a real-time decibel measurement reading from sound level meter (12) in an animated gauge form. Third indicia (52c) of the present example includes an animated gauge having various decibel ranges increasing in a clockwise direction and an arrow configured to selectively point toward the real-time decibel measurement reading within one of the decibel ranges. The decibel ranges may be color-coded to assist the user in determining the risk associated with the current level of sound. For example, the decibel ranges may be color-coded as green, green-yellow, yellow, orange, and red in the clockwise direction, with the green and green-yellow decibel ranges representing safe levels of sound, the yellow decibel range representing cautious levels of sound, the orange decibel range representing increased cautious levels of sound, and the red decibel range representing hazardous levels of sound. For example, third indicia (52c) in FIG. 5 shows the arrow selectively pointing toward 83 dBA, which may be within the orange decibel range. In some versions, second indicia (52b) may also include the current date and/or time.

In the example shown, fourth indicia (52d) visually communicates a rolling TWA of real-time decibel measurement readings from sound level meter (12) in a numerical form. Fourth indicia (52d) of the present example includes the rolling TWA presented as a numeral measured in decibels and based on a predetermined rolling time period of 12 months. The numerals presented may be color-coded to assist the user in determining the risk associated with the rolling TWA level of sound, such as in a manner similar to that described above with respect to third indicia (52c). For example, fourth indicia (52d) in FIG. 5 shows the rolling TWA presented as 87 dBA, which may be color-coded as red. In some versions, fourth indicia (52d) may also include the rolling time period (e.g., 12 months).

In the example shown, fifth indicia (52e) visually communicates a present day maximum decibel measurement reading from sound level meter (12) in a numerical form. The numerals presented may be color-coded to assist the user in determining the risk associated with the maximum level of sound experienced on the present day, such as in a manner similar to that described above with respect to third indicia (52c). For example, fifth indicia (52e) in FIG. 5 shows the maximum reading presented as 102 dBA, which may be color-coded as red. In some versions, fifth indicia (52e) may also include the current date and/or time.

In the example shown, sixth indicia (52f) presents a graphical control element including a search box and/or calendar button through which the user may input a query based on desired date and/or time ranges for retrieving a historic sound level report (60) associated with the inputted date and/or time ranges, as described in greater detail below.

In the example shown, seventh indicia (52g) visually communicates predictive sound measurements in numeric form. In addition, seventh indicia (52g) presents a risk score of “high” indicating that system (10) is anticipating measurements from sound level meter (12) to be above a predetermined sound level threshold which may be, for example 85 dBA. Risk scores that may be presented by seventh indicia (52g) may include but not be limited to “high,” “medium,” “low,” “caution,” and “none,” for example, each of which may correspond to predetermined sound level thresholds and/or ranges, and which may be presented by seventh indicia (52g) in response to system (10) anticipating measurements from sound level meter (12) that are above the respective threshold and/or within the respective range.

In the example shown, eighth indicia (52h) visually communicates predictive decibel measurement readings from sound level meter (12) in a graphical form. The graph also illustrates the predictive decibel measurements compared to the actual real-time measurements reflected in second indicia (52b) and shown as a dashed (e.g., for assessing the accuracy of the predictive decibel measurements). Eighth indicia (52h) of the present example includes a Y-axis representing decibel levels and an X-axis representing a predetermined time period. For example, eighth indicia (52h) in FIG. 5 shows predictive and real-time decibel levels plotted versus time over the course of a single day. In some versions, eighth indicia (52h) may also include the current and/or a future date and/or time.

In the example shown, ninth indicia (52i) visually communicates a control panel including various real-time operating statistics and/or status identifiers associated with sound level meter (12), such as any one or more of a status identifier of whether sound level meter (12) is online, a status identifier of a battery level of sound level meter (12), a status identifier of a cellular signal of sound level meter (12), a status identifier of when sound level meter (12) last heard (e.g., received) soundwaves (W), and/or an operating statistic of the number of sound levels recorded from sound level meter (12).

In the present version, a separate user interface (50) may be provided for each sound level meter (12) (and/or the corresponding zone (Z1, Z2, Z3, Z4, Z5). In some cases, all user interfaces (50) may be provided simultaneously by display (32) such that the user may monitor sound level meters (12) at the same time. Alternatively, the user may toggle between the various user interfaces (50) provided for each sound level meter (12) via display (32) to monitor each sound level meter (12) individually.

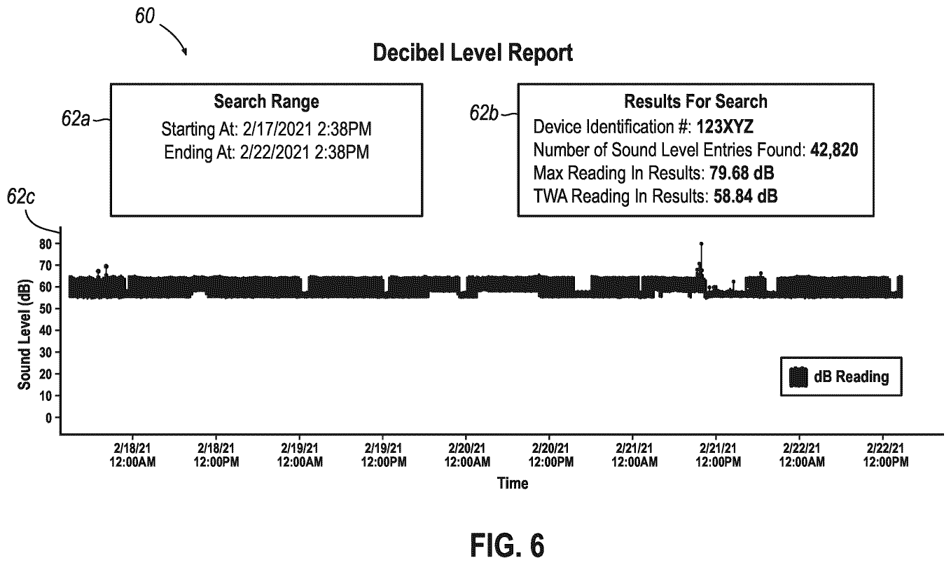

Referring now to FIG. 6, an exemplary historic sound level report (60) generated by system (10) in response to a user's query inputted via the graphical control element presented by sixth indicia (52f) of user interface (50) includes a plurality of report indicia (62a, 62b, 62c) for visually communicating various types of data or other information associated with the query to the user.

In the example shown, first report indicia (62a) visually communicates the search range (e.g., time period) of the query inputted by the user, which may include a textual identification of the start date and/or time and the end date and/or time, for example.

In the example shown, second report indicia (62b) visually communicates the search results responsive to the query inputted by the user, which may include textual identifications of the particular sound level meter(s) (12) which recorded the sound level measurements returned by the search, the number of sound level entries returned by the search (e.g., the number of sound pressure data points that were measured during the search range), the maximum sound level measurement returned by the search, and/or the TWA of the sound level measurements returned by the search.

In the example shown, third report indicia (62c) visually communicates the historical decibel measurement readings corresponding to the search range from sound level meter (12) in a graphical form. Third report indicia (62c) of the present example includes a Y-axis representing decibel levels and an X-axis representing the time period for the search range. For example, third report indicia (62c) in FIG. 6 shows decibel levels plotted versus time over the course of each day within the search range.

Thus, historic sound level report (60) may provide accurate and reliable visibility and access to sound levels recorded by system (10), which may provide improved recording efficiencies, at least by comparison to manual documentation and storage of sound level measurements.

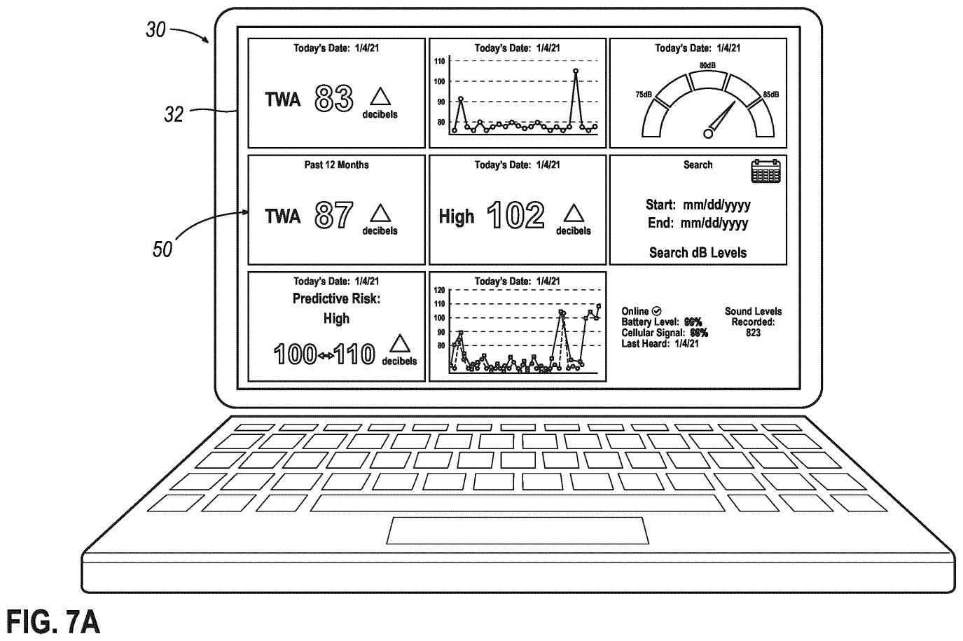

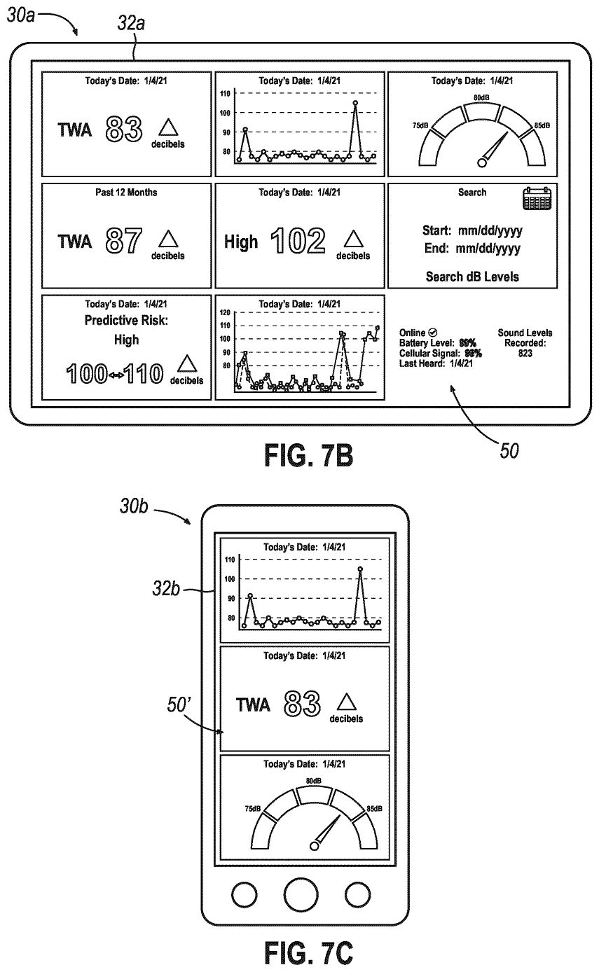

As shown in FIGS. 7A-7C, user interface (50) may be provided via display (32) of laptop computer (30) or via a display of any other suitable computing device, such as via a display (32a) of a tablet (30a) or a display (32b) of a smartphone (30b). In the example shown, user interface (50) may be resized, reformatted or otherwise modified to conform to display (32b) of smartphone (30b) as conformed user interface (50′), such as by reducing the number of indicia (52a, 52b, 52c, 52d, 52e, 52f, 52g, 52h, 52i) shown and/or by distributing indicia (52a, 52b, 52c, 52d, 52e, 52f, 52g, 52h, 52i) across multiple pages which the user may navigate (e.g., scroll or click) between. While not shown, user interface (50) may also be provided via a display of a smartwatch, in which case user interface (50) may likewise be resized, reformatted or otherwise modified to conform to such a display. While not shown, historic sound level report (60) may also be provided via any one or more of displays (32a, 32a, 32b), and/or may be printable.

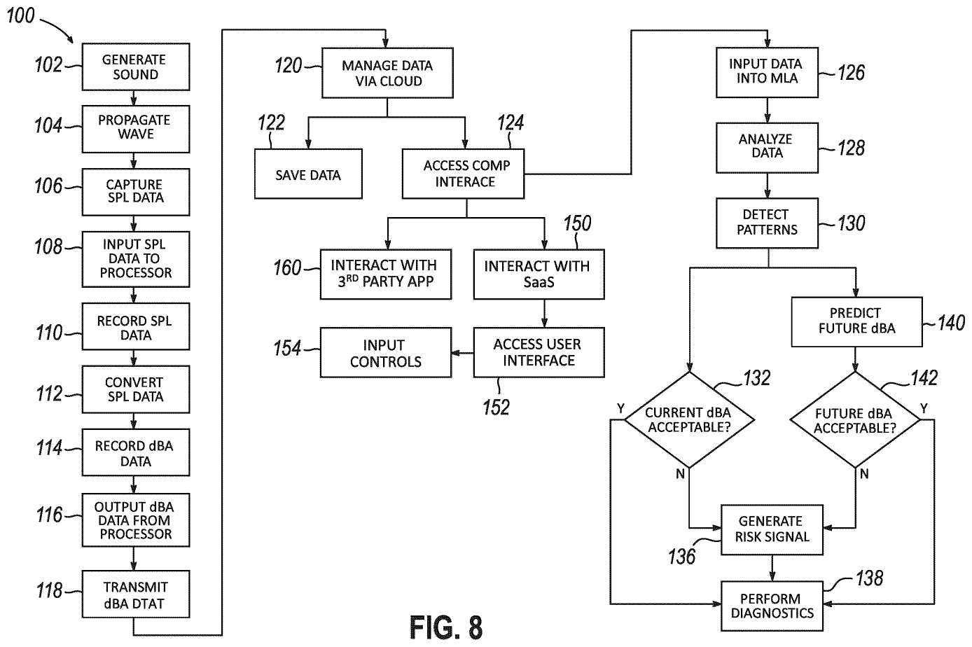

Referring now to FIG. 8, an exemplary method (100) for monitoring sound levels that may be performed by system (10) begins at step (102), whereat an event, such as operation of a machine, generates a sound. Method (100) proceeds from step (102) to step (104), at which the generated sound is carried by one or more soundwaves (W) (e.g., through the corresponding zone (Z1, Z2, Z3, Z4, Z5)). Method (100) proceeds from step (104) to step (106), at which raw SPL data is captured from the one or more soundwaves (W), such as by microphone (22) of one or more sound level meters (12). Method (100) proceeds from step (106) to step (108), at which the raw SPL data is inputted into a processor, such as the respective processor (24) of the one or more sound level meters (12). Method (100) proceeds from step (108) to step (110), at which the raw SPL data is recorded by processor (24). Method (100) proceeds from step (110) to step (112), at which the raw SPL data is converted into one or more decibel measurements by processor (24), which may be performed via a predetermined logarithmic formula, such as:

$${L}_{p} = 20 {log}_{10} ( p / {p}_{0} )$$

Method (100) proceeds from step (112) to step (114), at which the calculated decibel measurements (or “decibel measurement data”) are recorded by processor (24). Method (100) proceeds from step (114) to step (116), at which the decibel measurement data is outputted from processor (24), such as to the respective transceiver (26) of the one or more sound level meters (12). Method (100) proceeds from step (116) to step (118), at which the decibel measurement data is continuously transmitted by transceiver (26), such as through network (40), to a server, such as cloud server (42). Method (100) proceeds from step (118) to step (120), at which cloud server (42) manages various input and output data, including the decibel measurement data received from transceiver (26). Method (100) proceeds from step (120) to step (122), at which the decibel measurement data (e.g., both current/new decibel measurement data and historical decibel measurement data) is saved on a secure server location, such as cloud-based storage (34).

Method (100) also proceeds from step (120) to step (124), at which cloud server (42) accesses a computing interface, such as computing interface (44), for interacting with other software and/or applications. In this regard, method (100) proceeds from step (124) to step (126), at which the new decibel measurement data is inputted in real-time into a machine learning algorithm (e.g., connected to cloud server (42) via computing interface (44)) for learning sound patterns and predicting future sound patterns. Method (100) proceeds from step (126) to step (128), at which the machine learning algorithm analyzes the new decibel measurement data. Method (100) proceeds from step (128) to step (130), at which the machine learning algorithm detects decibel patterns by comparing the new decibel measurement data against historical decibel measurement data (e.g., retrieved from cloud-based storage (34)) and/or calculates TWAs. Method (100) proceeds from step (130) to step (132), at which the machine learning algorithm determines whether the current decibel levels are acceptable, such as whether the current decibel levels are within a predetermined range (e.g., 65 dBA to 75 dBA) and/or whether a TWA based on the current decibel levels is below a predetermined threshold (e.g., 85 dBA). If the machine learning algorithm determines that the current decibel levels are unacceptable, then method (100) proceeds to step (136), at which an automated risk alert signal is generated and communicated to the user, and further proceeds to step (138), at which various diagnostics are performed as described below. If the machine learning algorithm determines that the current decibel levels are acceptable, then method (100) proceeds directly to step (138) for such diagnostics.

Method (100) also proceeds from step (130) to step (140), at which the machine learning algorithm predicts future decibel levels based on the detected decibel patterns. Method (100) proceeds from step (140) to step (142), at which the machine learning algorithm determines whether the predicted future decibel levels are acceptable, such as whether the predicted future decibel levels are within a predetermined range (e.g., 65 dBA to 75 dBA) and/or whether a TWA based on the predicted future decibel levels is below a predetermined threshold (e.g., 85 dBA). If the machine learning algorithm determines that the predicted future decibel levels are unacceptable, then method (100) proceeds to step (136), at which the automated risk alert signal is generated and communicated to the user, and further proceeds to step (138) for diagnostics. If the machine learning algorithm determines that the predicted future decibel levels are acceptable, then method (100) proceeds directly to step (138) for such diagnostics.

At step (138), current and predictive decibel level data evaluated through the machine learning algorithm are reported for a full diagnosis and analysis, and the data is inputted back into the machine learning algorithm for continued learning of rules, patterns, and behaviors associated with the decibel levels, and is also transmitted to cloud server (42) via computing interface (44) for data record keeping in cloud-based storage (34) and/or for other purposes described below.

Method (100) also proceeds from step (124) to step (150), at which cloud server (42) interacts, via computing interface (44), with software-as-a-service (e.g., a web-based application), which may include any one or more of displaying current and/or historic data (e.g., real-time decibel level measurements, auto-calculated TWAs, predictive sound levels, historic sound levels, automated risk alerts, search and reporting capabilities), enabling the management of current, historic, and predictive decibel level recordings and data analytics, and/or allowing a user to view and/or control certain operating controls or other parameters of sound level meter (12) and/or system (10), such as via user interface (50). Method (100) proceeds from step (150) to step (152), at which the user accesses user interface (50), such as remotely, to view, monitor, and manage decibel level data recordings generated by sound level meter (12) and decibel analytics provided by the machine learning algorithm, for example, and/or to send communications to sound level meter (12) such as on/off commands or other controls. In this regard, method (100) proceeds from step (152) to step (154), at which various controls are inputted to processor (24), such as via cloud server (42). Such controls may include any one or more of software updates, remote calibration, on/off commands, automated risk alert signals, and/or instructions for converting the raw SPL data into decibel measurements.

Method (100) also proceeds from step (124) to step (160), at which cloud server (42) interacts, via computing interface (44), with additional applications and integrations, which may include any associated third party applications.

In some versions, equipment and machine maintenance may be performed based on the sound data obtained in method (100). For example, the predictive sound levels may indicate that preventative maintenance should be performed on the machine whose operation generated the sound at step (102).

While method (100) has been described as being performed in a particular order, it will be appreciated that various portions of method (100) may be performed in orders different from that described, and that certain portions may be omitted from method (100) in some versions.

While zones (Z1, Z2, Z3, Z4, Z5) have been described as being identified based on a predetermined amount of noise exposure that an employee or other personnel is subject to experience when located therein, zones (Z1, Z2, Z3, Z4, Z5) may alternatively be defined by the range of the respective sound level meter (12) positioned therein. For example, rather than deriving a predetermined amount of noise exposure for each zone (Z1, Z2, Z3, Z4, Z5), sound level meters (12) may be positioned throughout facility (F) at desired intervals based on the ranges of sound level meters (12) such that the range of each sound level meter (12) may define a respective zone (Z1, Z2, Z3, Z4, Z5).

As described above, sound level meters (12) may each be strategically positioned within the respective zone (Z1, Z2, Z3, Z4, Z5). Once installed at their respective locations, sound level meters (12) may provide substantially autonomous, continuous, and/or versatile sound level monitoring capabilities and/or bi-directional communication capabilities between the sound level meter (12) and the user. For example, sound level meters (12) may provide substantially autonomous sound level monitoring capabilities since they do not require human involvement to measure, monitor, or record sound pressure levels, thereby reducing or eliminating any human error to provide improved accuracy of the sound pressure data. Sound level meters (12) may provide substantially continuous sound level monitoring capabilities since they may be programmed to measure sound pressure levels during a specific time period on a repeated basis (e.g., during regular operating hours within facility (F)), and to continuously measure sound pressure levels during this period to provide a true indication of the noise exposure or decibel levels in the corresponding zone (Z1, Z2, Z3, Z4, Z5) rather than being restricted to “time and place” measurements or to a single person's noise exposure. Sound level meters (12) may provide versatile sound level monitoring capabilities since they may record sound levels directly from the source of the sound to provide improved precision of the sound pressure data, and since the rechargeable battery and mounting capabilities of some versions of sound level meters (12) may enable them to be positioned in areas or on objects that are difficult to access. Sound level meters (12) may provide bi-directional communication capabilities with the user to allow important information to be sent and received in real-time, which may include a safety notification communicated to the user in response to sound levels exceeding a predetermined threshold, such as 85 dBA.

While system (10) has been described herein for providing continuous sound level monitoring, it will be appreciated that system (10) may additionally or alternatively provide intermittent and/or impulsive sound level monitoring. For example, sound level meters (12) may be used to intermittently obtain sound level data at predetermined time intervals throughout a certain time period, and/or may be used to impulsively obtain sound level data in a randomized manner and/or on-demand (e.g., in response to a user input request).

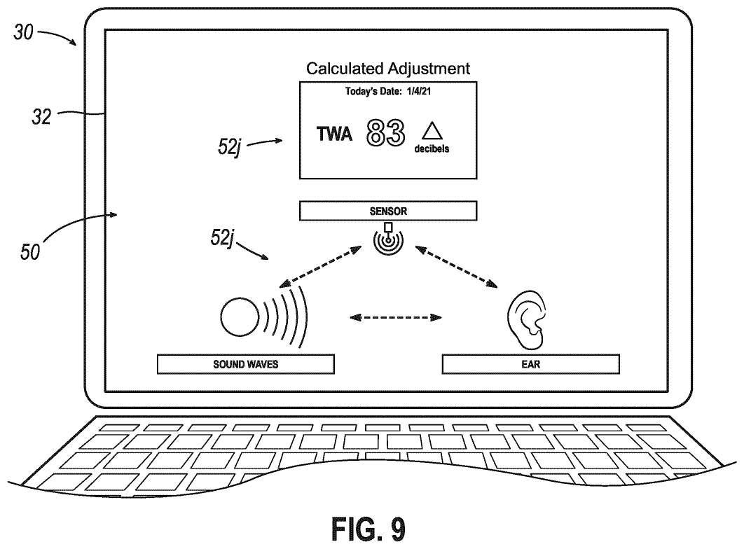

Referring now to FIG. 9, one or more tenth indicia (52j) may be incorporated into user interface (50) of system (10) described above in connection with FIG. 5, for visually communicating an adjusted sound pressure level that the ear(s) of one or more workers or other personnel in an associated zone (Z1, Z2, Z3, Z4, Z5) are actually exposed to. As shown, tenth indicia (52j) may be displayed on a dedicated screen, such that a user may toggle between the screen shown in FIG. 9 and that shown in FIG. 7A which visually communicates first through ninth indicia (52a, 52b, 52c, 52d, 52e, 52f, 52g, 52h, 52i), for example. In other versions, tenth indicia (52j) may be included on the same screen as first through ninth indicia (52a, 52b, 52c, 52d, 52e, 52f, 52g, 52h, 52i). In any event, the adjusted sound pressure level may be calculated by system (10) based on the measured ambient sound pressure level(s) described above while also taking into account various environmental and/or behavioral factors.

In this regard, multiple mediums and elements can cause sound wave reflection, refraction, or diffraction thereby altering sound pressure levels, such that sound pressure levels may increase or decrease based on mediums that the sound waves travel through. Thus, a sound pressure level adjustment algorithm associated with system (10) may incorporate and calculate multiple data points from environmental, atmospheric, location, distance, time, dose, barriers, hearing protection devices, human behavior and other situational conditions and mediums that alter sound waves and sound pressure levels. Such an algorithm may convert the measured ambient sound pressure level to an adjusted sound pressure level that the human ear is actually exposed to. Such an algorithm may receive such information any suitable sources, such as through engineering or integration with third-party sensors such as visual, temperature, air quality, motion, GPS, audio, tilt, vibration, etc., and/or with other third-party devices such as cellphones, mobile computing devices, etc. into the calculation. The algorithm may encompass software calculations, predetermined formulas and machine learning algorithms that compute measured, recorded, known, historic, assumed, estimated, or predicted data.

The conversion from measured ambient sound pressure level to adjusted sound pressure level may be performed via a predetermined formula, a simplified version of which is provided as follows: Adjusted Sound Pressure Level=(Measured Sound Pressure Level+/−Sound Mediums)*Dose.

In the present example, tenth indicia (52j) shown in FIG. 9 displays an adjusted sound pressure level of 80 db, while first indicia (52a) shown in FIG. 5 displays an ambient sound pressure level of 83b, representing a difference of 3 db. Thus, in calculating the adjusted sound pressure level, system (10) may account for data (e.g., assumed or user inputted) that the worker(s) or other personnel is using hearing protection or any other suitable barrier medium for dampening the noise exposure by 3 db, and/or may determine that the remaining environmental and/or behavioral factors taken into account have a net zero effect.

FIG. 10 illustrates an exemplary work environment including a plurality of sound level meters (12) and showing various real-world mediums, conditions, interferences and human behavioral elements to adjust ambient noise levels to the actual estimated sound pressure exposure to the ear of a person (P) and taken into account by system (10) when calculating the adjusted sound pressure level, such as that represented by ninth indicia (52j) in FIG. 9. More particularly, FIG. 10 demonstrates a potential real-world work environment and sound traveling through multiple mediums that intensify or lessen sound pressure levels. Speed of sound is affected by the medium the sound wave is traveling through and the compressibility and inertia of the medium material.

FIG. 10 shows a first source location (L1) at which a first sound is being generated and a second source location (L2) at which a second sound is being generated. FIG. 10 further shows the dispersion (D1) of sound waves generated from the first source, including the directional path of the sound waves and the mediums that the sound waves interact with. Likewise, FIG. 10 shows the dispersion (D2) of sound waves generated from the second source, including the directional path of the sound waves and the mediums that the sound waves interact with. FIG. 10 also shows an environmental medium (M), such as wind, which may disturb the directional path and/or intensity of the sound waves.

FIG. 10 further shows the medium temperature (T). In this regard, Speed of sound in air is affected by the temperature and humidity, causing sound waves to move faster at higher temperatures and slower at lower temperatures. Calculating the temperature effects on sound can be measured and evolved from a predetermined speed of sound formula, such as: v=331 m/s+ (0.6 m/s° C.) T, where V is the speed of sound and T is the temperature of the air.

FIG. 10 also shows the medium (e.g., air) quality (Q). In this regard, air pollutants are commonly found in industrial work environments. Pollutants fall into categories of particles and gases. These pollutants may include but not limited to dust such as lead, wood, rubber, pharmaceuticals, pesticides, coal, food, metals and more. Additionally, air pollutants can be ototoxic causing additional risk of hearing loss.

FIG. 10 also shows the distance (D) from the second source location (L2) to the ear of the person (P), which has a significant impact on actual sound pressure levels experienced by the person (P). A predetermined formula may be used to calculate sound pressure levels over distance, such as the inverse square law formula: Lp(R2)=Lp(R1)−20·Log₁₀(R2/R1), where Lp1=sound pressure level at location 1 (dB), Lp2=sound pressure level at location 2 (dB), R1=distance from source to location 1 (ft, m), and R2=distance from source to location 2 (ft, m).

FIG. 10 also shows the factor noise dose (N). In this regard, it will be appreciated that lower sound pressure level exposure at a longer duration of time, may have the same intensity level as higher sound pressure exposure at a shorter duration of time. For example, according to OSHA the action level for 8 hours of exposure is 85 dBA but the action level for 10 hours of exposure is 83.4 dBA. To calculate noise dose, a predetermined formula may be used such as: % Dose=100(C1/T1)+(C2/T2)+ . . . (Cn/Tn), where C=the exposure duration for the nth sound level and T=the corresponding allowed noise exposure.

FIG. 10 further shows the medium hearing protection device and human behavior element (B). In some versions, the effectiveness of hearing protection devices (HPD) may be estimated using a derating formula such as (NRR−7)/2=actual decibel level reduction. However, it will be appreciated that this generalized formula falls short on accuracy as it does not encompass unique sound medium interferences, and a flaw in the formula assumes hearing protection is being worn correctly. In this regard, human behavior can drastically alter the effectiveness of hearing protection and ultimately noise exposure. Such behavior or human error can include not properly wearing HPDs, wearing HPDs beyond their recommended use, HPDs coming loose from the ear, wearing inefficient HPDs, or not wearing HPDs at all. Thus, the use or non-use of hearing protection devices may be factored into calculation with derating equations and human behavior tendencies. For example, the predetermined formula described above may be modified as follows: Adjusted Sound Pressure Level=[Measured Ambient SPL+/−(sound mediums+human error)]*dose.

FIG. 10 also shows at least one sound level meter (12) attached, worn, or carried by person (P). The worn sound level meter (12) can have a 1 to 1 (device to internet) communication, or it can communicate and have connectivity to multiple other stationary sound level meters (12). Connection to one or more sound level meters (12) can be integrated through bluetooth, wifi, radio frequency, wire, cellular and other connectivity channels. Multiple sound level meters (12) in communication provides the ability to integrate data readings from each sound level meter (12) computing multiple mediums and elements to accurately pinpoint the sound source and exposure to sound pressure levels in real-time.

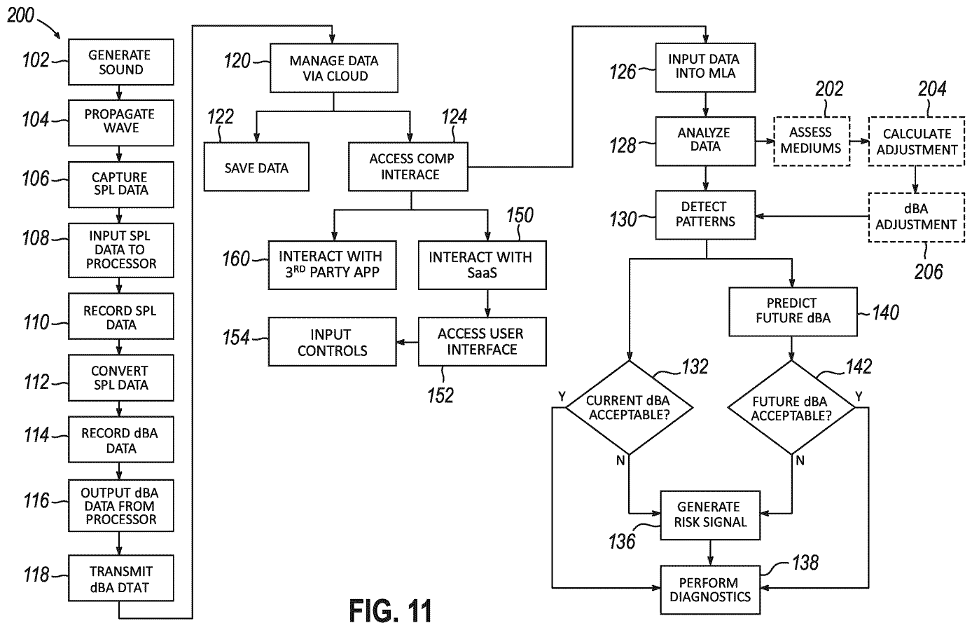

Referring now to FIG. 11, another exemplary method (200) for monitoring sound levels may be performed by system (10), and is similar to method (100) described above except as otherwise described below. In this regard, method (200) integrates an artificial intelligence algorithm into the steps of method (100) to calculate the adjusted sound pressure level taking into account various environmental and/or behavioral factors such as those described above.

More particularly, method (200) proceeds from step (128) to step (202) at which the algorithm assesses sound mediums collected from one or more sensors. Method (200) proceeds from step (202) to step (204), at which sound medium corrections are acknowledged and computed for the calculated adjusted sound pressure level. Method (206) proceeds from step (204) to step (206), at which the sound pressure level calculated adjustment is determined by the difference between values obtained in step (106) and step (204). Method (200) proceeds from step (206) to step (130) and the continuing steps for predictive adjusted sound pressure levels. In some versions, method (200) may also return from step (206) to step (120) and the remaining steps (122), (124), (160), (150), (152), (154) in parallel with proceeding to step (130).

### EXAMPLES

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A sound level monitoring system, comprising: (a) at least one sound level meter configured to collect sound pressure level data from a soundwave and to convert the collected sound pressure level data into a sound level measurement; (b) a network in operative communication with the at least one sound level meter for receiving the sound level measurement therefrom; (c) a cloud server in operative communication with the network for receiving the sound level measurement therefrom; and (d) a computing interface in operative communication with the cloud server for receiving the sound level measurement therefrom, wherein the computing interface is configured to provide the sound level measurement in response to a digital request from a software application.

### Example 2

The sound level monitoring system of Example 1, wherein the at least one sound level meter comprises a plurality of sound level meters.

### Example 3

The sound level monitoring system of Example 2, wherein each sound level meter of the plurality of sound level meters is positioned in a respective zone of a facility.

### Example 4

The sound level monitoring system of Example 3, wherein each sound level meter of the plurality of sound level meters is fixedly positioned in the respective zone of the facility.

### Example 5

The sound level monitoring system of any one or more of Examples 1 through 4, wherein the at least one sound level meter comprises at least one acoustic sensor.

### Example 6

The sound level monitoring system of Example 5, wherein the at least one acoustic sensor includes at least one microphone.

### Example 7

The sound level monitoring system of any one or more of Examples 5 through 6, wherein the at least one sound level meter further comprises at least one processor operatively coupled to the at least one acoustic sensor.

### Example 8

The sound level monitoring system of Example 7, wherein the processor is configured to apply a logarithmic conversion to the collected sound pressure level data.

### Example 9

The sound level monitoring system of any one or more of Examples 7 through 8, wherein the at least one sound level meter further comprises at least one transmitter operatively coupled to the at least one processor, wherein the at least one transmitter is in operative communication with the network via an internet connection.

### Example 10

The sound level monitoring system of any one or more of Examples 1 through 9, wherein the computing interface is configured to determine whether the sound level measurement is greater than a threshold sound level, and to provide an alert in response to determining that the sound level measurement is greater than the threshold sound level.

### Example 11

A sound level meter, comprising: (a) an acoustic sensor configured to collect sound pressure level data from a soundwave; (b) a processor operatively coupled to the acoustic sensor and configured to convert the collected sound pressure level data into a sound level measurement; and (c) a transmitter operatively coupled to the processor and configured to communicate the sound level measurement to a remote recipient via an internet connection.

### Example 12

The sound level meter of Example 11, further comprising a receiver operatively coupled to the processor and configured to communicate operating commands to the processor.

### Example 13

The sound level meter of Example 12, wherein the transmitter and the receiver are presented by a transceiver.

### Example 14

The sound level meter of any one or more of Examples 11 through 13, wherein the acoustic sensor includes a microphone.

### Example 15

The sound level meter of any one or more of Examples 11 through 14, wherein the processor is configured to determine whether the sound level measurement is greater than a threshold sound level, and to provide an alert in response to determining that the sound level measurement is greater than the threshold sound level.

### Example 16

A method for monitoring sound levels, comprising: (a) collecting sound pressure level data from a soundwave; (b) converting the sound pressure level data into at least one sound level measurement via a processor; and (c) communicating the at least one sound level measurement to a remote recipient in real-time via an internet connection.

### Example 17

The method of Example 16, further comprising displaying the at least one sound level measurement via a graphical user interface.

### Example 18

The method of any one or more of Examples 16 through 17, further comprising: (a) determining whether the at least one sound level measurement is greater than a threshold sound level; and (b) providing an alert in response to determining that the at least one sound level measurement is greater than the threshold sound level.

### Example 19

The method of any one or more of Examples 16 through 18, further comprising storing the at least one sound level measurement via a cloud server.

### Example 20

The method of any one or more of Examples 16 through 19, further comprising predicting future sound levels based on the at least one sound level measurement.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1-20. (canceled)

21. A sound level monitoring system, comprising:
at least one sound level meter configured to (a) collect sound pressure level data from a soundwave and (b) convert the collected sound pressure level data into real-time sound level measurements of an environment around a user; and
a computing device communicably coupled to the at least one sound level meter, the computing device comprising:
one or more processors; and
a memory storing instructions that, when executed by the one or more processors, cause the computing device to:
receive, from the at least one sound level meter, a current real-time sound level measurement of the environment around the user;
retrieve a plurality of historic sound level measurements of the environment around the user;
generate a prediction for future sound levels in the environment around the user based, at least in part, on the current real-time sound level measurement and the plurality of historic sound level measurements; and
in response to a determination that the future sound levels in the prediction exceed a predetermined threshold, communicating a risk alert to the user.

22. The sound level monitoring system of claim 21 wherein the at least one sound level meter comprises a microphone having an accuracy reading of at least ±2 A-weighted decibels.

23. The sound level monitoring system of claim 21 wherein the prediction for future sound levels comprises a predicted time-weighted average, and wherein the predetermined threshold for the predicted time-weighted average is 85 A-weighted decibels (dBA).

24. The sound level monitoring system of claim 21 wherein the instructions further cause the computing device to save the current real-time sound level measurement to the plurality of historic sound level measurements for use in future predictions.

25. The sound level monitoring system of claim 21 wherein generating the prediction for future sound level measurements comprises:
training a machine learning algorithm on the plurality of historic sound level measurements to generate a predicted time-weighted average for the user based on an input sound level measurement; and
providing, to the machine learning algorithm, the current real-time sound level measurement as the input sound level measurement to generate the predicted time-weighted average,
wherein the predetermined threshold comprises a predetermined limit for the predicted time-weighted average.

26. The sound level monitoring system of claim 25, wherein the at least one sound level meter is first sound level meter from a plurality of sound level meters distributed in the environment of the user, and wherein the plurality of historic sound level measurements comprise measurements from each of the plurality of sound level meters.

27. The sound level monitoring system of claim 26 wherein the predicted time-weighted average is based at least partially on a prediction of a distance between the user an each of the plurality of sound level meters.

28. The sound level monitoring system of claim 21 wherein generating the prediction for future sound level measurements comprises calculating an adjusted sound level measurement from the current real-time sound level measurement, and wherein calculating the adjusted sound level measurement comprises:
identifying a type of hearing protection worn by the user; and
applying a scaling factor to the current real-time sound level measurement based on (a) the type of hearing protection worn by the user and (b) an estimation of human error.

29. A method for operating a sound level monitoring system, the method comprising:
receiving, from a communication component operably coupled to at least one sound level meter, a real-time sound level measurement of an environment around a user;
retrieving, from a cloud server operably coupled to the at least one sound level meter, historic sound level measurements of the environment around the user;
generating a prediction for future sound level measurements in the environment around the user based at least partially on the real-time sound level measurement and the historic sound level measurements; and
in response to a determination that the future sound level measurements in the prediction exceed a predetermined threshold, communicating a risk alert to the user.

30. The method of claim 29 wherein generating the prediction for the future sound level measurements comprises calculating a predicted time-weighted average for the user, and wherein the predetermined threshold comprises a predetermined limit for the predicted time-weighted average.

31. The method of claim 30, wherein the predetermined limit for the predicted time-weighted average is 85 A-weighted decibels (dBA).

32. The method of claim 29 wherein the at least one sound level meter is first sound level meter from a plurality of sound level meters distributed in the environment of the user, and wherein the method further comprises:
receiving, from each of the plurality of sound level meters, sound level measurements during a recording period; and
storing the sound level measurements from the recording period in the cloud server as the historic sound level measurements.

33. The method of claim 29 wherein the at least one sound level meter is first sound level meter from a plurality of sound level meters, wherein each of the plurality of sound level meters is positioned in a respective zone of a facility, and wherein the historic sound level measurements comprise measurements from each of the plurality of sound level meters.

34. The method of claim 29, further comprising calculating an adjusted sound level measurement from the real-time sound level measurement, wherein the prediction for the future sound level measurements in the environment is further based at least partially on the adjusted sound level measurement.

35. The method of claim 34 wherein calculating the adjusted sound level measurement comprises determining adjustments based on one or more of:
an indication of whether the user is wearing a hearing protection device;
a difference between a first distance between a sound source and the user and a second distance between the at least one sound level meter and the sound source; and/or
a temperature of air in the environment around the user.

36. The method of claim 34 wherein calculating the adjusted sound level measurement comprises:
identifying a type of hearing protection worn by the user; and
applying a scaling factor to the real-time sound level measurement based on (a) the type of hearing protection worn by the user and (b) an estimation of human error.

37. The method of claim 29 wherein communicating the risk alert to the user comprises sending, to a user device associated with the user, a message causing the user device to display the risk alert to the user.

38. A method for operating a sound level monitoring system, the method comprising:
receiving, at a remote computing device, a first real-time sound level measurement of a work environment for a user from at least one sound level meter positioned to collect sound pressure level data from soundwaves in the work environment;
sending, from the remote computing device to the at least one sound level meter, one or more control signals based on the first real-time sound level measurement, wherein the one or more control signals comprise a command to initiate a calibration method;
receiving, at the remote computing device, a second real-time sound level measurement of the work environment from the at least one sound level meter after the calibration method;
determining, based on the second real-time sound level measurement of the work environment, that the second real-time sound level measurement exceeds a predetermined threshold; and
communicating, from the remote computing device, a risk alert to the user.

39. The method of claim 38, wherein the risk alert is a first risk alert, wherein the predetermined threshold is a first predetermined threshold, and wherein the method further comprises:
retrieving historic sound level measurements of the work environment;
generating a prediction for future sound level measurements in the work environment based at least partially on the second real-time sound level measurement and the historic sound level measurements; and
in response to a determination that the future sound level measurements in the prediction exceed a second predetermined threshold, communicating, from the remote computing device, a second risk alert to the user.

40. The method of claim 38 wherein the calibration method is configured to maintain an accuracy of the at least one sound level meter at ±2 A-weighted decibels or better.
